(19) United States
(12) Patent Application Publication
(10) Pub. No.: US 2024/0176476 A1
(43) Pub. Date: May 30, 2024

(54) CONFIGURATION DEVICE FOR CONFIGURING A POWER WHEELCHAIR

(71) Applicant: PERMOBIL AB, Timrå (SE)

(72) Inventor: Magnus Forslund, Alnö (SE)

(21) Appl. No.: 18/524,626

(22) Filed: Nov. 30, 2023

(30) Foreign Application Priority Data
Nov. 30, 2022 (EP) 22210621.3

(51) Int. Cl. G06F 3/04847; A61G 5/04; A61G 5/08; A61G 5/10; G06F 3/0481

(52) U.S. Cl. CPC G06F 3/04847; A61G 5/04; A61G 5/08; A61G 5/10; G06F 3/0481; A61G 5/14

(57) ABSTRACT

Methods, systems, and configuration devices for configuring settings of a power wheelchair. One configuration device includes a display unit configured to display a graphical representation, and an input unit configured to detect a user input changing a visual state of the graphical representation on the display unit from a first visual state to a second visual state, wherein every visual state of the graphical representation is associated with a set of wheelchair parameter settings. The configuration device also including processing circuitry configured to set the first visual state of the graphical representation based on data representing a current position of the power wheelchair, determine a set of wheelchair parameters associated with the second visual state of the graphical representation, and a communications unit configured to send the set of wheelchair parameters determined by the processing circuitry to a power wheelchair.

### RELATED APPLICATIONS

This application claims priority to European Patent Application No. 22210621.3, filed Nov. 30, 2022, the entire content of which is incorporated by reference herein.

### TECHNICAL FIELD

The present disclosure generally relates to power wheelchairs.

### BACKGROUND

Power wheelchairs typically comprise a control system which control functions, such as drive modes and seating sequences, of the wheelchair. Any re-programming of the control system involves adjusting a number of parameters and is thus rather cumbersome and unintuitive.

### SUMMARY

A general object of the present disclosure is to provide a configuration device for power wheelchairs which solves or at least mitigates the problems of the prior art.

There is hence according to a first aspect of the present disclosure provided a configuration device for configuring settings of a power wheelchair, comprising: a display unit arranged to display a graphical representation of a wheelchair functionality setting, an input unit arranged to detect a user input changing a visual state of the graphical representation on the display unit from a first visual state to a second visual state, wherein every visual state of the graphical representation is associated with a set of wheelchair parameter settings, processing circuitry arranged to determine a set of wheelchair parameters associated with the second visual state of the graphical representation, and a communications unit arranged to send the set of wheelchair parameters determined by the processing circuitry to a power wheelchair.

The configuration of the setting of the power wheelchair may thereby be simplified. Especially, the simplification is obtained because the visual states are associated with respective sets of wheelchair parameters that are used for programming the power wheelchair. Further, the configuration becomes standardised in the sense that only certain wheelchair parameter setting combinations are possible, as predefined by the set of wheelchair parameter settings associated with each visual state. The risk of erroneously configuring the power wheelchair is thus reduced. For example, a set of rules may be stored and applied for the power wheelchair (or each model of the power wheelchair), a particular user or type of user using the power wheelchair, or a combination thereof. Rules for a user or a type of user (e.g., a user experiencing a particular injury or disorder) may represent positions that such a user can tolerate or positions that are beneficial for such a user. A clinician, therapist, or caretaker, an employee of the power wheelchair manufacturer, an external technician, or the like may define rules for a user or a particular type of user based on the user's condition. In some implementations, the power wheelchair is also associated with (and may provide) limitation values that represent physical limitations (e.g., set by the original equipment manufacturer (OEM)) of components of the power wheelchair (e.g., a range of angles that a leg rest of the power wheelchair can be positioned at using the available actuators and the overall physical structure of the wheelchair). These rules and limitations allow the wheelchair configuration to be standardised in that only certain parameter setting combinations are possible. These possible combinations may be reflected in the positions provided through the graphical representation, the wheelchair parameter settings associated with (e.g., mapped to) visual states of the graphical representation, or a combination thereof. For example, the graphical representation may be restricted in what visual states are available to prevent the wheelchair from being configured erroneously. Alternatively or in addition, the parameters mapped to the visual state may take into account the applicable rules and limitations as part of sending wheelchair parameters to the power wheelchair.

The communications unit may according to one example be configured to also send the set of wheelchair parameters to a remote database or server, e.g., in the cloud, or a database or server at a wheelchair fleet operator. Traceability of the programming history of the power wheelchair may thereby be provided. It is thus possible to recreate a configuration in case a faulty electronics component storing the wheelchair parameter settings programmed by means of the configuration device has to be replaced, or to configure a replacement power wheelchair.

According to one example, the processing circuitry may be arranged to pair the set of wheelchair parameters with a specific user identifier and the communications unit may be configured to send the set of wheelchair parameters with the associated specific user identifier to a remote database or server for storing the set of wheelchair parameters and the associated specific user identifier. The wheelchair parameters thus become associated with a specific user, and this facilitates factory configuration of a new power wheelchair in case a new wheelchair is ordered for the user associated with the specific user identifier. The new power wheelchair may thus be shipped to the user with a familiar wheelchair functionality configuration instead of having to be configured at delivery to a user.

According to one embodiment the processing circuitry is arranged to determine a set of wheelchair parameters for every intermediate visual state between the first visual state and the second visual state, and wherein the communications unit is arranged to send all sets to the power wheelchair. This may for example be the case if the wheelchair functionality setting is seat positioning. In this case, each intermediate visual state between the first visual position and the second visual position may be associated with e.g., respective sets of wheelchair actuator settings of a set of actuators controlling seat position, between the first visual position and the second visual position.

According to one embodiment the processing circuitry is arranged to determine an order of sequence of the sets associated with all the intermediate visual states, wherein the communications unit is arranged to send the order of sequence of the sets to the power wheelchair. Thus, for example in case the wheelchair functionality is seat positioning, the sequence order of the actuator positions for causing movement of a seating system of the power wheelchair between two seat positions is sent to the power wheelchair.

According to one embodiment the processing circuitry is arranged to determine the set of wheelchair parameters based on a look-up table, database, or a mathematical function that associates every visual state of the graphical representation with a set of wheelchair parameters.

According to one embodiment the wheelchair parameter settings include wheelchair actuator settings. The wheelchair actuator settings may be settings for controlling actuators, i.e., actuators that control a seating system of the powered wheelchair. For example, the actuator settings may specify a position (e.g., angle or extension), a speed of movement of the actuator, or a combination thereof. For example, some user disabilities require slower or softer motions than others, and, thus, the actuator settings can define a speed of movement, which may be based on a user profile. When a plurality of actuators are used simultaneously (e.g., dual actuators working in parallel or several actuators simultaneously moving different parts of the wheelchair), the actuator settings may define the motion of the actuators so that they move in synchrony or in appropriate combination. Thus, the processing circuitry is arranged to determine the set of wheelchair parameters and control the wheelchair to implement the set of parameters, such as, for example, by transmitting the wheelchair actuator settings to the wheelchair.

According to one embodiment the processing circuitry is arranged to receive an identifier associated with a power wheelchair, and in response thereto enable displaying of the graphical representation on the display unit, wherein the communications unit is arranged to send the set of wheelchair parameters to the power wheelchair associated with the identifier. The identifier may or may not be unique to the power wheelchair. The identifier may for example be a chassis identifier or serial number of the power wheelchair.

According to one embodiment the communications unit is arranged to receive the identifier only via a local wireless network of the power wheelchair. The communications unit may for example be configured to communicate with the power wheelchair via a wireless network protocol based on e.g., on the IEEE 802.11 family of standards, such as Wi-Fi®. The communications unit may alternatively be configured to communicate with the power wheelchair via a short-range wireless communications protocol such as Bluetooth®. It should be noted that also other means of wireless communication is contemplated within the scope of the present embodiments, such is IR, ultrasound, radio.

Alternatively, the communications unit may be configured to communicate with the power wheelchair via a communications protocol adapted for a wired connection between the configuration device and the power wheelchair.

According to one embodiment the wheelchair functionality setting is seat positioning, wherein the graphical representation is a view of a body showing a bodily position obtained by the body in a seat position of a seating system of the power wheelchair.

It should here be noted that the bodily position shown may represent the parameters of the seating system. As an example, the displayed angular position of the lower legs, may actually represent the angular position of the leg rest.

Power wheelchairs often have pivot points, such as a knee pivot points, corresponding to the knee joint or knee joint axis of the user. By showing the bodily position as a graphical representation, a better understanding of how the user's body will be positioned for a certain set of wheelchair parameters that control actuators, i.e., seating system actuators, is obtained than if e.g., visualising the seating system or providing no visualisation at all.

The processing circuitry may be configured to transform angles of the body displayed on the display unit showing the bodily position to wheelchair actuator settings as wheelchair parameters.

According to one example the processing circuitry may be configured to perform an animation of the body from the first visual state to the second visual state on the display unit. The animation may be formed by the position of the body in the first visual state, the intermediate visual states, and the second visual state. The animation may for example show a sequence of movements from a seated position to a standing position, or from a standing position to a seated position.

According to one embodiment every visual state is a different bodily position.

According to one embodiment the wheelchair functionality setting is the driving properties of the power wheelchair.

According to one embodiment the graphical representation comprises a slider, or one or more knobs.

According to one embodiment every visual state is a different position of the slider or the one or more knobs.

According to one example the configuration device is configured to retrieve a set of parameters for a wheelchair functionality setting from the power wheelchair. The parameters that define a certain wheelchair functionality setting of the power wheelchair may thus be sampled or retrieved by the configuration tool (e.g., as live, streamed values). This may include the vast majority of parameters and settings that are configurable by the configuration tool, meaning that manual settings performed on the wheelchair may be sampled or retrieved by the configuration tool. It may particularly include, but not be limited to, seating settings, such as angles, extensions, etc. The retrieved set of parameters may be mapped, by the configuration device, to a particular visual state of the graphical representation (e.g., similar to how the configuration device is configured to map a visual state of the graphical representation to a set of wheelchair parameters) and used to display the graphical representation in a state representing a current position or posture of the power wheelchair (e.g., a first visual state).

According to one example, the processing circuitry may be configured to display a guide for configuring a wheelchair functionality setting. The guide may for example be a step-by-step guide for configuring a wheelchair functionality setting. The programming of a power wheelchair may thus be facilitated in the field.

The guide may according to one example provide guidance for repair, maintenance, or upgrading work on the power wheelchair. Such repair, maintenance or upgrading work may for example involve changing of actuators.

There is according to a second aspect of the present disclosure provided a method comprising: a) displaying a graphical representation of a wheelchair functionality setting, b) detecting a user input changing a visual state of the graphical representation from a first visual state to a second visual state, wherein every visual state of the graphical representation is associated with a set of wheelchair parameter settings, c) determining a set of wheelchair parameters associated with the second visual state of the graphical representation, and d) sending the set of wheelchair parameters determined by the processing circuitry to a power wheelchair.

The method is a computer-implemented method.

According to one embodiment the determining involves determining a set of wheelchair parameters for every intermediate visual state between the first visual state and the second visual state, and the sending involves sending all sets to the power wheelchair.

According to one embodiment the determining involves determining an order of sequence of the sets associated with all the intermediate visual states, wherein the sending involves sending the order of sequence of the sets to the power wheelchair.

According to one embodiment the determining involves determining the set of wheelchair parameters based on a look-up table or database that associates every visual state of the graphical representation with a set of wheelchair parameters.

One embodiment comprises, prior to displaying, receiving an identifier associated with a power wheelchair, and in response thereto enabling displaying of the graphical representation on the display unit, wherein the sending involves sending the set of wheelchair parameters to the power wheelchair associated with the identifier.

Generally, all terms used in the claims are to be interpreted according to their ordinary meaning in the technical field, unless explicitly defined otherwise herein. All references to “a/an/the element, apparatus, component, means”, etc. are to be interpreted openly as referring to at least one instance of the element, apparatus, component, means, etc., unless explicitly stated otherwise.

### BRIEF DESCRIPTION OF THE DRAWINGS

The specific embodiments of the inventive concept will now be described, by way of example, with reference to the accompanying drawings, in which:

FIG. 1 is a block diagram of an example of a configuration device;

FIG. 2 schematically shows the configuration device in communication with a power wheelchair;

FIG. 3 is a flowchart of a method of configuring settings of a power wheelchair;

FIGS. 4A-4B schematically show a first example of configuration of settings of a power wheelchair;

FIGS. 5A-5D schematically show a second example of configuration settings of a power wheelchair; and

FIG. 6 shows another example of configuration settings of a power wheelchair.

### DETAILED DESCRIPTION

The inventive concept will now be described more fully hereinafter with reference to the accompanying drawings, in which exemplifying embodiments are shown. The inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

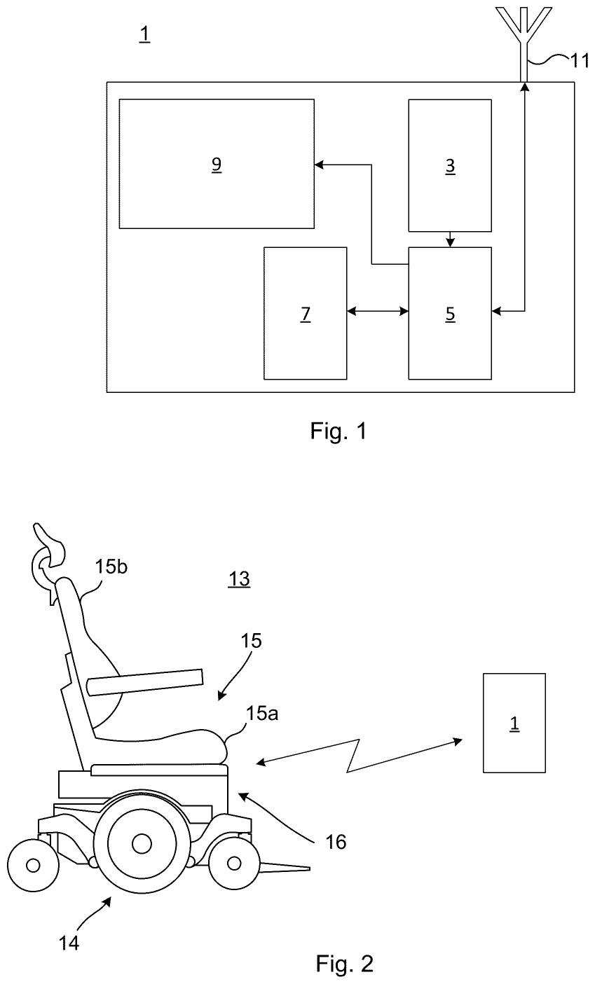

FIG. 1 schematically shows an example of a configuration device 1. The configuration device 1 is adapted to be used for configuring settings of power wheelchairs.

The configuration device 1 may be a handheld device. The configuration device 1 may for example be a dedicated handheld device for configuring settings of a power wheelchair, or it may be a mobile phone, a tablet computer or a laptop comprising computer code configured to execute the methods as disclosed herein.

The configuration device 1 comprises an input unit 3. The input unit 3 may for example be a hardware keyboard, or mouse, a touchscreen, or a combination thereof.

The input unit 3 is configured to detect a user input that is inputted to the configuration device 1.

The configuration device 1 comprises processing circuitry 5. The processing circuitry 5 may for example use any combination of one or more of a suitable central processing unit (CPU), multiprocessor, microcontroller, digital signal processor (DSP), application specific integrated circuit (ASIC), field programmable gate arrays (FPGA) etc., capable of executing any herein disclosed operations of configuring settings of a power wheelchair.

Depending on the type of processing circuitry 5, the control system may also comprise one or more storage medium 7. The one or more storage medium 7 is configured to communicate with the processing circuitry 5.

If present, the one or more storage medium 7 comprises computer code which when executed by the processing circuitry 5 causes the configuration device 1 to perform the steps of the methods described herein.

The/each storage medium 7 may for example be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory.

The configuration device 1 comprises a display unit 9. The processing circuitry 5 is configured to communicate with the display unit 9.

The configuration device 1 comprises a communications unit 11 configured to communicate with the processing circuitry 5 and with powered wheelchairs. The communications unit 11 may be configured as an antenna for wireless communication or as a communications interface for wired communication.

FIG. 2 schematically shows a system of a power wheelchair 13 and the configuration device 1. The power wheelchair 13 and the configuration device 1 are configured to communicate with each other wirelessly, by wired connection, or by both.

The power wheelchair 13 may be a midwheel drive wheelchair as shown in the example in FIG. 2, a front wheel drive wheelchair, a rear-wheel drive wheelchair, or a four-wheel drive wheelchair.

The power wheelchair 13 comprises drive wheels 14 and motors (not shown) configured to drive the drive wheels 14.

The power wheelchair 13 comprises a chassis 16 from which the drive wheels 14 are suspended.

The power wheelchair 13 comprises a seating system 15. The seating system 15 comprises a seat 15a and a backrest 15b. The seating system 15 may also comprise a leg rest.

The seating system 15 may be mounted to the chassis 16.

The power wheelchair 13 comprises a plurality of actuators (not shown) configured to actuate or manoeuvre the seating system 15.

The power wheelchair 13 includes a control system (not shown). The control system is configured to control wheelchair functionality such as speed, turning and drive modes by controlling the motors, and manoeuvring of the seating system 15 by controlling the actuators. For example, the control system may be configured to manoeuvre the seating system 15 between a seated position as shown in FIG. 2, and a standing position, for instance, in which the seat 15a has been tilted forward to attain an orientation of e.g., 60° or more relative to the horizontal plane.

The configuration device 1 is configured to program or configure settings of the control system, and thus the power wheelchair, for controlling the power wheelchair 13. These settings are not accessible to the user via the user interface of the power wheelchair 13.

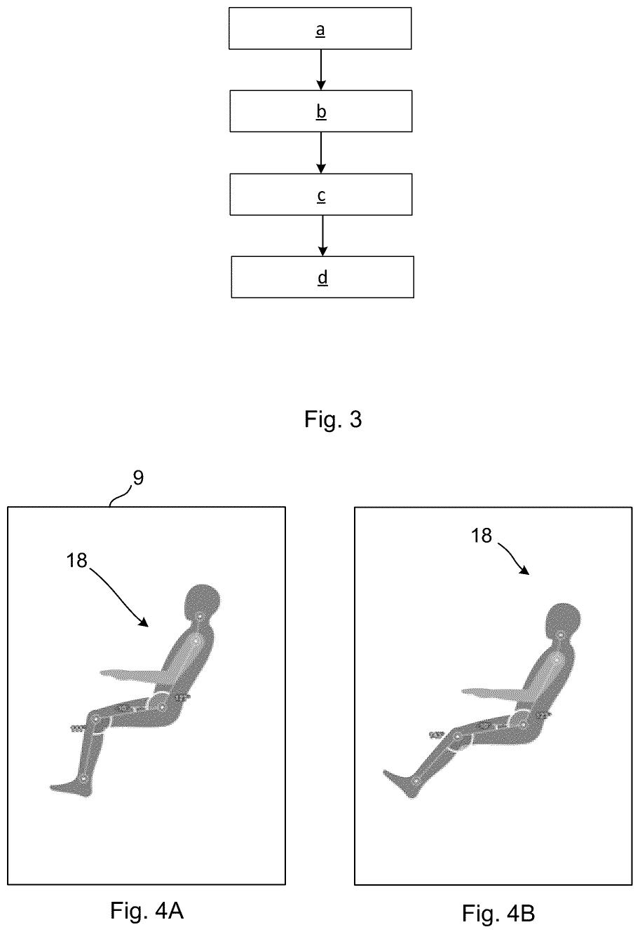

With reference to FIG. 3, a method of configuring settings of a power wheelchair such as power wheelchair 13 will now be described.

Typically, an employee of the power wheelchair manufacturer, an external technician, or a therapist may operate the configuration device 1 to configure the power wheelchair 13.

At some point, the connection or communications link is set up between the configuration device 1 and the power wheelchair 13. The connection may be wireless, or it may be wired. According to one example the configuration device 1 has to be close to the power wheelchair 13, for example within distance of reception of a local wireless network of the power wheelchair 13 or within distance for making short-range wireless communication possible. Alternatively, the connection or communications link may be a remote connection, for example via a wide area network.

The connection may be set up before step a) or any time after step a) but before step d) of the steps described in the following.

In a step a) a graphical representation of a wheelchair functionality setting is displayed on the display unit 9.

Prior to step a) the person operating the configuration device 1 may input an identifier associated with the power wheelchair 13 to the configuration device 1 via the input unit 3.

The processing circuitry 5 may be arranged to receive the identifier, and in response thereto enable displaying of the graphical representation on the display unit in step a). In some implementations, the configuration device 1 may initially communicate with the power wheelchair 13 over a first type of communication channel (e.g., a Bluetooth® connection) and may use the first communication channel to perform security and authentication functions, such as, for example validating a certificate provided via the power wheelchair 13, providing a certificate from the configuration device 1 to the power wheelchair 13, or a combination thereof. In response to the connection with the power wheelchair 13 being validated or confirmed (e.g., through certificate validation), the configuration device 1 and the power wheelchair 13 may establish a communication channel over a second, different type of connection (e.g., a Wi-Fi® connection). For example, in response to a validation or other security check being completed with the configuration device 1, the power wheelchair 13 may enable a communication module (e.g., a Wi-Fi® module) to exchange additional information with the configuration device 1 (e.g., a live stream of data, limitations, configuration settings, actuator settings, etc.). Using a first connection to perform initial validation (e.g., certificate validation) provides power management and security benefits by enabling a different type of connection (which may require additional power than the first type of connection) only when needed and only when communication has been validated. In some implementations, when the second connection is established, the configuration device 1 executes a web-based application or accesses a web-based service to view a list of one or more power wheelchairs the configuration device 1 (i.e., the user operating the configuration device 1) is authorized to configure. This list of power wheelchairs may be established (e.g., by an administrator) using a web-based service that manages available power wheelchairs. It should be understood that, in some implementations, the configuration device 1 is configured to use a particular type of connection for various functions, such as, for example, to perform initial validation, subsequent communication with the wheelchair or components thereof. For example, in some implementations, a Wi-Fi connection is used for communicating with the user's mobile phone and, optionally, with external sensors of the powered wheelchair (e.g., smart cushions, alternative drive input systems, etc.).

In some implementations, the configuration device 1 scans a label on the wheelchair 13 (e.g., a QR code or similar machine-readable code or device) to obtain a coded identifier of the wheelchair a label on the wheelchair contains a coded identifier (similar to a QR code). Scanning such a code helps ensure that 1) the correct wheelchair is identified, and 2) that the technician, therapist, etc. programming the wheelchair 13 is physically adjacent to the wheelchair 13, which provides a security measure. In some implementations, scanning the label also informs the configuration device 1 of the access point (or access point identity) for the computer on-board the power wheelchair 13 so that a connection for transferring data can be established.

In some implementations, the configuration device 1 is also configured to communicate with an authentication server that manages users and certificates (e.g., to obtain a certificate to provide to the power wheelchair 13 for validation purposes), a configuration server storing profiles of power wheelchairs configurable via the configuration device 1, including, for example, a history of configurations for a power wheelchair, or a combination thereof. Functionality provided via the authentication server and the configuration server may be combined and distributed in various ways including through one server or through multiple servers.

The configuration device 1, the configuration server, or both may also be configured to communicate with a fleet server storing usage history. In some implementations, the fleet server is configured to remotely configure the power wheelchair 13 (e.g., when the wheelchair 13 is first deployed, after maintenance, etc.) by transmitting configuration settings to the power wheelchair 13. Also, in some implementations, the power wheelchair 13 is configured to receive over-the-air (OTA) updates (e.g., firmware updates) in addition to receiving configurations from the configuration device 1, and such updates may be received from the fleet server.

In some implementations, the power wheelchair 13 provides an application programming interface (API) that acts as an interface between internal components (tools) of the power wheelchair 13 and external communications. Accordingly, the API allows the configuration device 1 to communicate with the power wheelchair 13 and receive and transmit information. The API may be configured to perform security and verification of data (e.g., parameter settings or other configuration data) received from the configuration device 1 as well as other sources. In some implementations, the power wheelchair 13 also includes a web application that acts as an intermediary between external communications and the API. To connect with and configure the power wheelchair 13, a user (of the configuration device 1) is registered (e.g., with the authentication server) as an authorized user, and, in response, the authentication server issues a certificate (e.g., associated with the authorized user) to the configuration device 1. The configuration device 1 stores the certificate.

The configuration device 1 is configured to scan for available power wheelchairs, such as via a first communication protocol (e.g., a Bluetooth® protocol). For example, when using a Bluetooth® protocol, the configuration device 1 may issue a discovery request and wait for a response from discoverable devices located around the configuration device 1, such as the power wheelchair 13. In a situation where the configuration device 1 receives multiple responses to a discovery request, the configuration device 1 may sort the received responses, such as, for example, based on signal strength, to select one available power wheelchair 13 (e.g., the wheelchair located closest to the configuration device 1). As noted above, in some implementations, the configuration device 1 scans (e.g., using a camera, bar code reader, or the like) a code affixed to a wheelchair to establish communication with a particular wheelchair.

To connect to the power wheelchair 13 after receiving a response to the discovery request, the configuration device requests a certificate from the power wheelchair 13 (which may similarly be issued and maintained by the authentication server as described above with respect to the user certificate) and validates the received certificate (e.g., locally on the configuration device 1 or via communication with the authentication server). In response to validating the certificate from the power wheelchair 13, the configuration device 1 sends the stored user certificate to the power wheelchair 13, which validates the certificate (e.g., locally on the power wheelchair 13 or via communication with the authentication server). In response to validating the certificate provided by the configuration device 1, the power wheelchair 13 informs the configuration device 1 that a connection can be established and may enable an internal Wi-Fi® module to establish a Wi-Fi® connection with the configuration device 1. The configuration device 1 may configure the Wi-Fi® connection (e.g., based on an identifier of the local area network established via the power wheelchair 13, a password or other access credentials for the network, or the like) and connect to the power wheelchair via the Wi-Fi® connection. It should be understood that other types of communication protocols may be used to connect and exchange information between the configuration device 1 and the power wheelchair 13 and the use of Bluetooth® and Wi-Fi® is provided as one non-limiting example.

After connecting with the power wheelchair 13 over the Wi-Fi® connection, the configuration device 1 reads status and configuration information (e.g., through a web-based API provided on the power wheelchair 13 as described herein) and transmit configuration settings to the power wheelchair 13 over the Wi-Fi® connection as part of a configuration session. In some implementations, the configuration device 1 also communicates with the configuration server to back-up the configuration session established with the power wheelchair 13.

The wheelchair functionality setting may for example be seat positioning. In this case, the graphical representation is a view of a body showing a bodily position obtained by the body in a seat position of a seating system of the power wheelchair 13.

To set the graphical representation to a current (live) posture (which may be the first visual state in some scenarios as described herein), the configuration device 1 uses positioning values streamed from the power wheelchair 13. The positioning values may include or be generated (by the power wheelchair 13) based on, for example, values sensed by one or more sensors on the power wheelchair 13, positions of actuators of the power wheelchair 13, or the like. In some implementation, the power wheelchair 13 may store a set of current positioning values that may be tracked by the power wheelchair 13 based on prior configuration settings (e.g., default settings or settings received from the configuration device 1 or other servers in communication with the power wheelchair 13), sensed by various sensors of the power wheelchair 13 detecting current positions, or a combination thereof. For example, in some implementations, manual configurations can also be performed at the power wheelchair 13 and, thus, as previously noted, the configuration device 1 may sample or retrieve such configurations (or sensed positions) when such configurations are implemented at the power wheelchair 13. The configuration device 1 maps received streamed values (individually or as a set) to a particular visual state of the graphical representation, which, as described above, may be stored in a look-up table or database stored on or otherwise accessible to the configuration device 1.

In a step b) a user input changing the visual state of the graphical representation on the display unit from the first visual state to a second visual state is detected. The processing circuitry 5 may detect the user input changing the visual state of the graphical representation.

The configuration device 1 may provide one or more input mechanisms configured to receive a change to the visual state of the graphical representation on the display unit. In some implementations, the configuration device 1 may receive input through one or more of the input mechanisms to change the visual state of the graphical representation. For example, the graphical representation (or portions thereof) provided via the configuration device may be selectable, such as, for example, using a drag and move input to change a position of the graphical representation or a portion thereof. The drag and move input may be provided through a touchscreen of the display unit of the configuration device 1. In some implementations, a portion of the graphical representation may be movable through a predetermined set of positions (visual states), wherein each position may be mapped to a one or more wheelchair parameters (e.g., via a look-up table or other data structure as described above). In some implementation, one or more portions of the graphical representation may be independently movable. In other implementations, one or more portions of the graphical representation may be linked such that movement of one portion triggers movement (i.e., a change in position) of a different portion of the graphical representation. For example, to maintain the wheelchair position within a range of acceptable postures or positions, movement of one portion of the graphical representation may trigger movement of one or more other portions. In some implementations, one or more sliders, knobs, or other types of input mechanisms may similarly be provided on the configuration device 1 to change the visual state of the graphical representation.

Alternatively or in addition to changing the visual state of the graphical representation through a drag and move input, a user interface or other type of input mechanism (e.g., one or more buttons, switches, or the like) of the configuration device 1 may be configured to receive a (numerical) value of a position (e.g., an angle from a reference plane, a level from a plurality of defined levels, a percentage of a maximum incline or decline, or the like). For example, the configuration device 1 may be configured to receive (e.g., through one or more fields or menus provided via a user interface displayed on the display unit) a set of position values representing a recipe for a particular desired posture, which may be provided to the user by a clinician, therapist, or caretaker, an employee of the power wheelchair manufacturer, an external technician, or the like.

Alternatively or in addition, the configuration device 1 may receive changes to a displayed graphical representation from the power wheelchair 13, wherein the changes represent a sample portion or a full posture of the wheelchair. For example, a user, therapist, technician, etc. may adjust the wheelchair 13 (e.g., at the wheelchair 13) to specific settings appropriate to the user and settings for such parameters can be transmitted to the configuration device 1 (e.g., via a Wi-Fi connection).

In some implementations, regardless of how changes are made to the visual state of the graphical representation, the configuration device 1 is configured to wait until a confirmation or commit input is received (e.g., through a user interface provided via the configuration device 1 or a different input mechanism) before transmitting one or more wheelchair functionality settings to the power wheelchair, another server, or a combination thereof.

Using the confirmation or commit functionality allows a user to see the visual states of various inputs and allows the configuration device 1 to generate appropriate configuration settings before corresponding position changes are implemented at the power wheelchair 13, which makes more efficient use of bandwidth resources (communication with the power wheelchair 13) and power resources of the power wheelchair 13 and helps mitigate human errors in wheelchair positioning. Every visual state of the graphical representation may be associated with a set of wheelchair parameter settings. Each such set of wheelchair parameter settings may be unique. There may thus be a one-to-one mapping between sets of parameter settings and visual states.

In a step c) a set of wheelchair parameters associated with the second visual state of the graphical representation are determined. As described herein, the configuration device 1 may use a look-up table, a database, or other data structure mapping a set of parameter settings to a particular visual state.

Accordingly, when changes are made (and committed) to the graphical representation, the configuration device 1 uses this stored mapping to determine the corresponding set of parameter settings for the changed visual state of the graphical representation. For example, as described above, a portion of the graphical representation (e.g., legs) may be movable between a range of discrete positions (which may be represented by different numerical values), wherein each position is associated with a particular parameter setting (e.g., a numerical value) for an actuator of the wheelchair 13. Thus, the configuration device 1 uses a current position of the graphical representation (or a portion thereof) to determine a corresponding parameter setting (e.g., from the look-up table or database) and may perform this mapping for each movable portion of the graphical representation to determine a set of parameters for a current visual state of the graphical representation as displayed on the configuration device 1.

For example, the processing circuitry 5 is arranged to determine the set of wheelchair parameters. The processing circuitry 5 may for example determine the set of wheelchair parameters associated with the second visual state based on a look-up table or database that associates every visual state of the graphical representation with a set of wheelchair parameters. Alternatively, the processing circuitry 5 may determine the set of wheelchair parameters associated with the second visual state based on a mapping, or mathematical function, between body angles of the body 18 in a visual state to corresponding actuator settings for setting the seating system 15 in a position in which the body 18 attains the angles when supported by the seating system 15. The processing circuitry 5 may be arranged to determine a set of wheelchair parameters for every intermediate visual state between the first visual state and the second visual state.

For example, the configuration device 1 may use the first visual state (e.g., a current position of the power wheelchair 13 as determined based on the (live) data stream from the power wheelchair 13) and the second visual state as determined based on the graphical representation as changed (and committed) by the user on the configuration device 1 to determine a sequence of movements to be implemented at the power wheelchair 13 to implement the second visual state of the graphical representation. Each movement (intermediate visual state) in the sequence may designate operating instructions for one or more actuators of the power wheelchair 13 to bring the power wheelchair 13 closer to the second visual state. For example, assuming, as one non-limiting example, the first visual state represents the legs at an angle of 90° and the back at an angle of 105° (e.g., from a ground plane) and the second visual state represents the legs at an angle of 120° and the back at an angle of 135° (e.g., from the ground plane), the configuration device 1 may determine a set of intermediate positions that may initially adjust the leg rest to 120° (as a first intermediate position) and then adjust the back rest to 135° (as a second intermediate position). In some implementations, the configuration device 1 is configured to determine one or more intermediate positions for each positioning actuator of the power wheelchair 13, which, when combined represent a sequence of movements. Alternatively, the configuration device 1 may be configured to combine one or more intermediate positions when a plurality of actuators of the power wheelchair can be operated simultaneously. For example, if a leg rest and a back rest of the power wheelchair 13 can be adjusted simultaneously, one intermediate position determined by the configuration 1 may represent movement of both the leg rest and the back rest. The configuration device 1 may store one or more operation rules that can be applied to control whether actuators can be operated simultaneously, whether an actuator has any requirements that changes over a particular range be performed in a stepwise manner, and the like. For example, when tilting the seat forward to bring a user to a standing position, the seat may also be raised to prevent a foot support from hitting the ground and the configuration device 1 may be programmed to understand this dependency when defining movements for reaching a target (e.g., standing position).

As a further example, via the configuration device 1, a user can create a memory position using the graphical representation of the body position. A memory position may represent the simplest form of movement including only one “frame” that takes the wheelchair 13 from a current position to the targeted memory position. A more advanced type of memory position is a sequence and includes a plurality of “frames,” wherein implementation of the memory position takes the wheelchair 13 from a current position through all the frames until the target (memory position) is reached. As described herein, each “frame” can be edited using the body graphical representation presented within the user interface, by sampling the position from the wheelchair 13, by entering values manually, or a combination thereof. The axes included in the movement may also be selected on the configuration device 1 for both memories and sequences. Seating axes may represent a seating function as compared to the position of a simple actuator. For example, examples of such seating axes may include a seat tilt (angle), a backrest recline (angle), a leg rest tilt (angle), and a leg extension (millimetre or inch). Accordingly, as compared to setting particular actuator positions, a user can use the configuration device 1 to easily set a desired position using the body graphical representation and setting one or more seating axes.

As one non-limiting example, a memory position may be labelled as “kitchen table” and may represent appropriate wheelchair settings when a user is sitting at a kitchen table. In contrast, a more advanced sequence can be, for example, a stand position (e.g., from a seated position to a (fully) standing position), an active reach position (e.g., to reach something on a shelf where the seat is slightly raised and slightly tilted forward), a transfer position (e.g., to move into bed or vehicle), or independent repositioning (e.g., moving the wheelchair 13 to slide the user back in the seat to get a better posture or obtain pressure relief). For example, the memory sequences may allow a user to initially go into a laying down position and the be lifted into a standing or any other position instead of going directly to the target position (e.g., standing).

The configuration device 1 may store rules (e.g., for specific axes for specific wheelchair models) that are applied by the configuration device 1 to restrict what is possible to do using the displayed body representations before any memories are stored for a particular power wheelchair 13. For example, while the power wheelchair 13 may be configured to control what positions and movements are possible, the configuration device 1 may be configured to validate values to ensure that a user, technician, etc. doesn't program the wheelchair 13 to do something that will be rejected by the wheelchair 13. The configuration device 1 may apply stored rules and associated limits (e.g., associated with at least one of the wheelchair 13 (e.g., rules and limited associated with a specific wheelchair model, components of the wheelchair 13 controlling motion or positions, or combination thereof) and a user of the wheelchair 13 (e.g., a medical or physical condition of the user, a preference of the user, a behavior setting of the wheelchair 13 as set by a user, or a combination thereof) to validate the values (i.e., a set of wheelchair parameters). In response to validating the values, the configuration device 1 sends the set of wheelchair parameters to the power wheelchair 13 (e.g., via the communications unit).

The processing circuitry 5 may be arranged to determine an order of sequence of the sets associated with all the intermediate visual states. In some implementations, after the configuration device 1 determines the intermediate visual states (positions or states) as described above, the configuration device 1 may show an animation of the movement of the power wheelchair 13 on the display unit (e.g., by displaying the set of intermediate visual states as a timed sequenced, like a movie), and, optionally, prompt a user to accept or confirm the determined intermediate visual states before the intermediate visual states (or instructions based on the same) are sent to the power wheelchair 13. Accordingly, in this implementation, a user can confirm not only the desired end position of the power wheelchair 13 but also that the motion the wheelchair 13 will progress through to reach the end position is acceptable.

In a step d) the set of wheelchair parameters determined by the processing circuitry 5 are sent to the power wheelchair 13. The wheelchair functionality settings for a certain function may thus be set for the power wheelchair 13.

As noted above, the configuration device 1 may also be configured to send the wheelchair parameters (directly or through the wheelchair 13 and/or other intermediary devices) to a remote database or server, e.g., in the cloud, or a database or server at a wheelchair fleet operator (e.g., the fleet server) to allow configurations for the power wheelchair 13 to be recreated. For example, if a user of the power wheelchair receives a new power wheelchair, stored configurations for the user's old power wheelchair may be provided (e.g., through the fleet server) to the user's new power wheelchair. Similarly, if maintenance or repairs are performed on a power wheelchair, stored prior configurations may be provided (e.g., through the fleet server) to ensure that the power wheelchair is returned to a usable position. If an identifier was received by the processing circuitry 5 prior to step a) the communications unit 11 may be arranged to send the set of wheelchair parameters to the power wheelchair 13 associated with the identifier. The communications unit 5 may be arranged to send the order of sequence of all the sets, in case of several sets, to the power wheelchair 13. The data sent from the configuration device 1 to the power wheelchair 13 may include the wheelchair parameter settings associated with each determined intermediate visual state or step. For example, when the user, technician, clinician, etc. creates and stores a memory position or a sequence via the configuration device 1, the configuration device 1 sends a set of parameter settings to the power wheelchair 13. For memory sequences, the transmitted parameter settings include a list of values, with one value for each step or frame. The power wheelchair 13 stores the received values after validating the values as being acceptable/allowed. However, as noted above, the configuration device 1 is configured to apply the appropriate rules and limits for the power wheelchair 13 (i.e., validate the settings) to mitigate the need for any error messages from the power wheelchair 13 regarding improper or prohibited values. The power wheelchair 13 executes the received values via the actuators as defined via a control system of the power wheelchair 13.

When the power wheelchair 13 has received the set or sets of wheelchair parameters, the control system of the power wheelchair 13 may set the corresponding parameters (actuator settings) for controlling the power wheelchair 13 to the values of the set or sets of wheelchair parameters received.

Examples of configuring settings of a power wheelchair will now be described with reference to FIGS. 4A to 6.

FIGS. 4A-4B show an example where the setting of a power wheelchair, such as power wheelchair 13, that is configured is a memory setting of the seating system.

On the power wheelchair, a pre-programmed memory setting may be selected by the user of the power wheelchair by means of a user interface of the power wheelchair. The pre-programming, or configuration, of the memory setting is made by means of the method disclosed herein.

When a memory setting is selected by means of the user interface, the seating system and the leg rest are set in positions or states in accordance with the set of wheelchair parameters obtained and stored by the power wheelchair as a result of step d) of the present method.

The graphical representation is in the example of FIGS. 4A-4B a view of a body 18 showing the bodily position of a user seated in a power wheelchair. The seating system 15 is according to the example not visualised. The first visual state of the graphical representation shows an upright seated bodily position.

Angles that may optionally be displayed in the graphical representation may be the angles of the corresponding components of the seating system, e.g., the seat, the backrest, and/or of the leg rest.

When configuring, or re-configuring, the memory setting of the seating system, the operator of the configuration device 1 may make a user input via the input unit 3, for example on the display unit 9 which may be a touch screen, changing the bodily position of the body 18 to a desired position (e.g., using a drag and move input as described above).

The operator may for example change the leg rest position of the memory setting by moving the leg upwards, as shown in FIG. 4B. This corresponds to a change of the visual state of the graphical representation on the display unit 9 from the first visual state, shown in FIG. 4A to a second visual state.

The processing circuitry 5 is configured to determine the set of wheelchair parameters associated with the second visual state. The communications unit 11 then sends the set of wheelchair parameters associated with the second visual state to the power wheelchair. As noted above, the wheelchair parameters may include a set of parameters and may represent a memory position or a memory sequence. When the set of parameters represent a memory position, the transmitted values may include parameters for the desired target position. In contrast, when the set of parameters represent a memory sequence, the transmitted values may include one or more values for each frame or step of the sequence. For example, a leg rest of the power wheelchair 13 may change from one position to another without the need for any intermediate states and the power wheelchair 13 implements the received set of parameters to change the current state (first state) of the wheelchair 13 to the command state (second state) per the received information such that the change in position occurs in the most efficient manner (e.g., quickly), per configurations of the leg rest and/or the wheelchair 13, or a combination thereof. The settings of the control system concerning a memory setting of the seating system are thus configured or re-programmed in this manner.

When the wheelchair user next selects the corresponding memory setting on the user interface of the power wheelchair, the actuators of the seating system and leg rest will attain states that causes the user to be seated as show in FIG. 4B which in this case means that the leg rest attains a raised position.

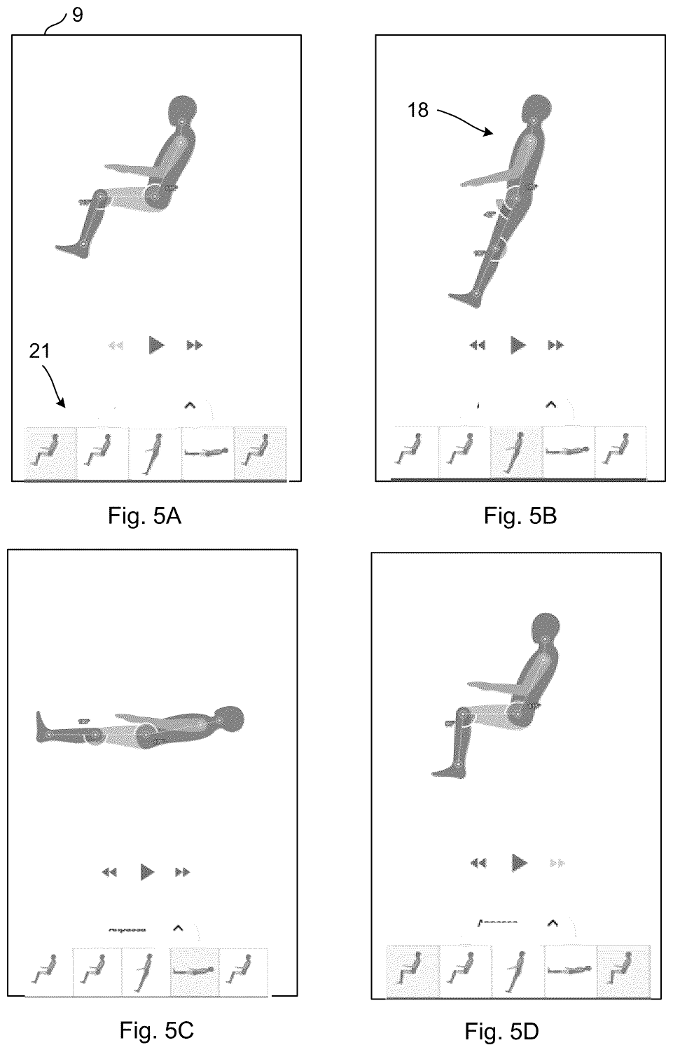

FIGS. 5A-5D show another example, where the setting of a power wheelchair, such as power wheelchair 13, that is configured is a sequence of movements of the seating system and the leg rest. The sequence of movements may for example be from an upright seated position to standing position and/or from standing position to the upright seated position.

The operator of the configuration device 1 may select a number of bodily positions of the body 18, and thus of the actuators of the seating system, to create a sequence of movements of the seating system and the leg rest. In the example shown in FIGS. 5A-5D, the number of user-settable positions of the body 18 in a sequence of movements may be five. However, more, or fewer user-settable positions are also contemplated in this embodiment. For example, in some implementations, the configuration device 1 may store a set of templates, wherein each template may define a default sequence of movements (which may represent a sequence of movements for transitions between two positions as verified or specified by the power wheelchair manufacturer, a clinician, therapist, or caretaker, or the like). The sequence of movements can be displayed as movie frames to provide an animation to the user of the configuration device 1 how the wheelchair position will change from a starting position to an end position (e.g., similar to how the determined intermediate states may be animated as described above). Each movement (frame) in the sequence may represent one full position of the power wheelchair 13 and may be individually customized using, for example, user changes to the body graphical representation. For example, a template may exist for a stand sequence that includes multiple positions, and the stand sequence can be animated on the display unit of the configuration device 1 before being sent to the power wheelchair 13 for implementation, which allows a user to better understand the full movement and what to expect from the power wheelchair when the sequence is executed. In some implementations, although each individual movement (frame) may be modified by a user, the configuration device 1 may be configured to apply rules, limitations, or a combination thereof as described above to maintain movements within physical limitations and user-specific rules. Each of the user-settable positions may for example be selected from a menu 21 which shows the user-settable positions of the sequence. When the operator changes the bodily position in each user-settable position of the sequence, the graphical representation for that user-settable position of the sequence is changed from a first visual state to a second visual state.

In the example, the upright seated position in FIG. 5A is a first visual state of the graphical representation and represents a first user-settable position of the sequence of movements of the seating system. If the upright seated position in FIG. 5A would be changed, then the first visual state is changed to a second visual state of this user-settable position. Every user-settable position may thus be set from a first visual state to a second visual state to configure a complete sequence of movements of the seating system. Bodily positions of the body 18 between the first visual state and the second visual state are intermediate visual states. The intermediate visual states between the first visual state and the second visual state may be pre-set. Each intermediate visual state is associated with a set of wheelchair parameters.

The wheelchair parameters of any visual state, i.e., first, second, and intermediate, are determined by the processing circuitry 5 for example by means of a look-up table, a database, or by means of a mathematical model/function.

FIG. 5B shows a standing position as a second-user definable position of the sequence.

Using the configuration device 1, the operator can configure a sequence of movements from e.g., a seated position to a standing position, and/or a seated position from a standing position, for example via a horizontal lying position shown in FIG. 5C.

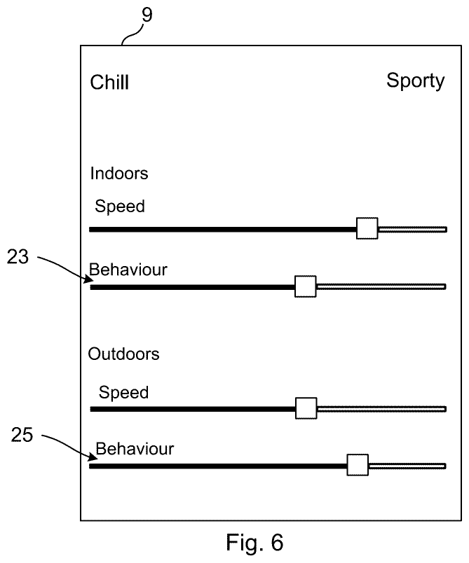

FIG. 6 shows another example where the setting of a power wheelchair, such as power wheelchair 13, that is configured is the driving properties of the power wheelchair 13. The driving properties may for example be driving modes.

The graphical representation may for instance comprise one or more sliders.

The sliders may represent different speeds or behaviour settings. For example, slider 23 may set the behaviour of the power wheelchair indoors. The behaviour may for example be varied between a “chill” mode and a “sporty” mode, which influences e.g., acceleration, speed, braking characteristics, and steering. These are wheelchair parameters that are determined when the slider 23 is changed from a first position corresponding to a first setting to a second position corresponding to a second setting. Similarly, the slider 25 may set the behaviour of the power wheelchair outdoors. The graphical representation may include one or more images indicating different options, such as, for example, indoor, outdoor, sporty, comfort, etc. As described herein, the sliders allow a user to do a simple change (e.g., a behavioural change) that affects one or more parameters, wherein the changes are visualized by the sliders along a scale with symbols or text.

The inventive concept has mainly been described above with reference to a few examples. However, as is readily appreciated by a person skilled in the art, other embodiments than the ones disclosed above are equally possible within the scope of the inventive concept, as defined by the appended claims.

1. A configuration device for configuring settings of a power wheelchair, comprising:
a display unit configured to display a graphical representation of a wheelchair functionality setting;
an input unit configured to detect a user input changing a visual state of the graphical representation on the display unit from a first visual state to a second visual state, wherein every visual state of the graphical representation is associated with a set of wheelchair parameter settings; and
processing circuitry configured to:
set the first visual state of the graphical representation based on data received from the power wheelchair representing a current position of the power wheelchair,
determine a set of wheelchair parameters associated with the second visual state of the graphical representation, and
send the set of wheelchair parameters to the power wheelchair via a communications unit,
the communications unit configured to send the set of wheelchair parameters determined by the processing circuitry to a power wheelchair for implementing the set of wheelchair parameters via one or more actuators of the power wheelchair.

2. The configuration device as claimed in claim 1, wherein the processing circuitry is configured to determine the set of wheelchair parameters by determining a set of wheelchair parameters for every intermediate visual state between the first visual state and the second visual state, and wherein the communications unit is configured to send the set of wheelchair parameters by sending all sets to the power wheelchair.

3. The configuration device as claimed in claim 2, wherein the processing circuitry is further configured to determine an order of sequence of the sets associated with all the intermediate visual states, wherein the communications unit is configured to send the set of wheelchair parameters by sending the order of sequence of the sets to the power wheelchair.

4. The configuration device as claimed in claim 1, wherein the processing circuitry is configured to determine the set of wheelchair parameters based on a look-up table, a database, or a mathematical function that associates every visual state of the graphical representation with a set of wheelchair parameters.

5. The configuration device as claimed in claim 1, wherein the wheelchair parameter settings include wheelchair actuator settings.

6. The configuration device as claimed in claim 1, wherein the processing circuitry is further configured to receive an identifier associated with a power wheelchair, and in response thereto enable displaying of the graphical representation on the display unit, wherein the communications unit is configured to send the set of wheelchair parameters by sending the set of wheelchair parameters to the power wheelchair associated with the identifier.

7. The configuration device as claimed in claim 1, wherein the wheelchair functionality setting is seat positioning, wherein the graphical representation is a view of a body showing a bodily position obtained by the body in a seat position of a seating system of the power wheelchair.

8. The configuration device as claimed in claim 7, wherein every visual state is a different bodily position.

9. The configuration device as claimed in claim 1, wherein the wheelchair functionality setting is driving properties of the power wheelchair.

10. The configuration device as claimed in claim 9, wherein the graphical representation comprises a slider or one or more knobs.

11. The configuration device as claimed in claim 10, wherein every visual state is a different position of the slider or the one or more knobs.

12. The configuration device as claimed in claim 1, wherein the processing circuitry is further configured to pair the set of wheelchair parameters with a specific user identifier, and wherein the communications unit is further configured to send the set of wheelchair parameters with the associated specific user identifier to a remote database or server for storing the set of wheelchair parameters and the associated specific user identifier, the wheelchair parameters thus becoming associated with a specific user.

13. The configuration device as claimed in claim 1, wherein the processing circuitry is further configured to validate the set of wheelchair parameters and send the set of wheelchair parameters to the power wheelchair in response to validating the set of wheelchair parameters.

14. The configuration device as claimed in claim 13, wherein the processing circuitry validates the set of wheelchair parameters using one or more stored rules associated with at least one selected from a group consisting of the power wheelchair and a user of the power wheelchair.

15. A method of configuring settings of a power wheelchair, the method comprising:
a) setting, with a configuration device remote from the power wheelchair and wirelessly communicating with the power wheelchair, a first visual state of a graphical representation of a wheelchair functionality setting based on data received from the power wheelchair representing a current position of the power wheelchair;
b) displaying, on a display unit of the configuration device, the graphical representation of the wheelchair functionality setting;
c) detecting, with the configuration device, a user input changing a visual state of the graphical representation from a first visual state to a second visual state, wherein every visual state of the graphical representation is associated with a set of wheelchair parameter settings;
d) determining, with the configuration device, a set of wheelchair parameters associated with the second visual state of the graphical representation; and
e) sending, with a communications unit of the configuration device, the set of wheelchair parameters to a power wheelchair for implementing the set of wheelchair parameters via one or more actuators of the power wheelchair.

16. The method as claimed in claim 15, wherein determining the set of wheelchair parameters includes determining a set of wheelchair parameters for every intermediate visual state between the first visual state and the second visual state, and wherein sending the set of wheelchair parameters includes sending all sets to the power wheelchair.

17. The method as claimed in claim 16, wherein determining the set of wheelchair parameters includes determining an order of sequence of the sets associated with all the intermediate visual states, and wherein sending the set of wheelchair parameters includes sending the order of sequence of the sets to the power wheelchair.

18. The method as claimed in claim 15, wherein determining the set of wheelchair parameters includes determining the set of wheelchair parameters based on a look-up table, a database, or a mathematical function that associates every visual state of the graphical representation with a set of wheelchair parameters.

19. The method as claimed in claim 15, further comprising, prior to displaying the graphical representation, receiving an identifier associated with a power wheelchair, and in response thereto enabling displaying of the graphical representation on the display unit, and wherein sending the set of wheelchair parameters includes sending the set of wheelchair parameters to the power wheelchair associated with the identifier.

20. The method as claimed in claim 15, further comprising validating the set of wheelchair parameters and wherein sending the set of wheelchair parameters to the power wheelchair includes sending the set of wheelchair parameters to the power wheelchair in response to validating the set wheelchair parameters.

21. The method as claimed in claim 20, wherein validating the set of wheelchair parameters includes validating the set of wheelchair parameters using one or more stored rules associated with at least one selected from a group consisting of the power wheelchair and a user of the power wheelchair.

22. A system for configuring settings of a power wheelchair, the system comprising:
a control system for the power wheelchair; and
a handheld configuration device, the handheld configuration device including:
an input unit,
a display unit,
a communications unit configured to wirelessly communicate with the control system for the power wheelchair,
processing circuity, and
storage medium comprising computer code that when executed by the processing circuitry causes the handheld configuration device to:
a) set a first visual state of a graphical representation of a wheelchair functionality setting based on data received from the power wheelchair representing a current position of the power wheelchair,
b) display, on the display unit, the graphical representation of the wheelchair functionality setting,
c) detect, through the input unit, a user input changing a visual state of the graphical representation from a first visual state to a second visual state, wherein every visual state of the graphical representation is associated with a set of wheelchair parameter settings,
d) determine a set of wheelchair parameters associated with the second visual state of the graphical representation, and
e) send, with the communications unit, the set of wheelchair parameters to the power wheelchair for implementing the set of wheelchair parameters via one or more actuators of the power wheelchair.

23. The system as claimed in claim 22, wherein the computer code, when executed by the processing circuitry, further causes the handheld configuration device to validate the set of wheelchair parameters and send the set of wheelchair parameters to the power wheelchair in response to validating the set of wheelchair parameters.

24. The system as claimed in claim 23, wherein the handheld configuration device validates the set of wheelchair parameters using one or more stored rules associated with at least one selected from a group consisting of the power wheelchair and a user of the power wheelchair.
